(19) United States
(12) Patent Application Publication
(10) Pub. No.: US 2014/0172157 A1
(43) Pub. Date: Jun. 19, 2014

(54) Portable Pay At The Pump

(71) Applicants: Samuel W. Bellamy, III, Bryn Mawr, PA (US); Christopher R Kronenthal, Narberth, PA (US)

(72) Inventors: Samuel W. Bellamy, III, Bryn Mawr, PA (US); Christopher R Kronenthal, Narberth, PA (US)

(21) Appl. No.: 13/714,625

(22) Filed: Dec. 14, 2012

(51) Int. Cl. G07F 11/00

(52) U.S. Cl. CPC G07F 11/002
USPC 700/232

(57) ABSTRACT

Present systems utilize a number of various and distinct energy dispensing stations, message controllers, and point-of-sale devices. In traditional systems, the consumer initiates a purchase through direct interaction with the point-of-sale. The proposed system herein functions as software-as-a-service (SaaS) solution for (electronic payment, discounts and loyalty programs. In the proposed system the Consumer initiates the purchase through their mobile device.

The Consumer initiates a purchase via a consumer device application. The device captures the dispenser identification, as appropriate. The portable device accumulates the dispenser identification, localized data, and unique mobile data, then securely transmits the data elements to the gateway system via the mobile network, Internet, or private data network requesting a pre-authorization and dispenser activation. The Solution retrieves the pre-authorization and injects the approval into the store-level point-of-sale as typical. The balance of the transaction occurs as with other solutions today.

### CROSS REFERENCE TO RELATED APPLICATIONS

This application claims benefit from U.S. Provisional Patent Application No. 61/684,387 filed on Aug. 17, 2012 and U.S. Patent Application Nos. U.S. 2012/0130832 filed on May 24, 2012, U.S. 2012/0136957 A1 filed on May 31, 2012, U.S. 2011/0276717 A1 filed on Nov. 10, 2011, and U.S. 2011/0276531 A1 filed on Nov. 10, 2011, which are hereby incorporated by reference.

### REFERENCED U.S. APPLICATION DATA

| | | |
|---|---|---|
| 6,321,984 | Nov. 27, 2001 | McCall et al. |
| 6,332,128 | Dec. 18, 2001 | Nicholson |
| 6,732,081 | May 04, 2004 | Nicholson |
| 6,778,967 | Aug. 17, 2004 | Nicholson |
| 6,885,996 | Apr. 26, 2005 | Nicholson |
| 7,383,204 | Jun. 03, 2008 | McCall et al. |
| 7,653,571 | Jan. 26, 2010 | Jacoves et al. |
| 7,742,942 | Jun. 22, 2010 | Nicholson |

### FIELD OF THE INVENTION

The present invention relates to systems and methods of electronic transactions, and more particularly to systems and methods of commercial and financial transaction using consumer mobile devices, point-of-sale devices, fuel dispensers, electronic charging stations, compressed natural gas dispensers, master host platforms, gateways, payment processing host platforms, and incentives (electronic coupon, voucher, loyalty, and discount) host platforms.

### BACKGROUND OF THE INVENTION

The traditional utility of an electronic payment authorization and fueling station authorization implements an electronic mechanism incorporated into the fuel dispenser for the purpose of identifying the consumer payment method. By example, this may be a magnetic stripe reader (MSR) or RFID reader for the purpose of reading consumer payment information from a physical card using either of magnetic stripe technology or RFID chip technology. The purchase process consists of the consumer initiating the purchase at the fuel dispenser with the insertion or swipe of their payment card into the reading device at the select fuel dispenser. In the case of RFID, the consumer places the chip card in close proximity to the RFID reader embedded into the select fuel dispenser. The card reader initiates a pre-authorization against the issuing bank provisioning credit for the consumer for a pre-determined maximum financial amount (e.g. $75.00) by routing the electronic transaction securely from the card reader through a pump controller (network controller local to the fueling facility which manages all pump operations) to the acquiring network to the issuing bank for the purpose of validating sufficient credit and credit status for the select card for the pre-determined financial amount. Upon success at the issuing bank, a pre-authorization message in response traverses the communication path in reverse to the pump controller. Upon receipt of the successful pre-authorization, the pump controller activates (power on) the select fuel dispenser.

As of this writing there are several patents relevant to electronic payment and pricing adjustments specific to fuel dispensing stations. These patents specifically reference the use of an electronic device for reading a payment card and price adjustment from the local point-of-sale. These processes require expensive peripherals fully and securely integrated into the fuel dispenser for the purpose of capture consumer payment information and credentials and the optical scanning of paper coupons. These processes incur risks to the consumer is loss of benefit due to faded and worn thermal paper receipts. For thermal receipts the barcode read rate success is significantly less than with fully electronic redemption techniques of this invention.

U.S. Pat. No. 6,321,984 (McCall et al, Nov. 27, 2001) describes a Customer Activated Terminal (“CAT”) integral to the fuel dispenser used in the identification of the consumer for the purposes of redeeming fuel discounts on the basis of other purchases. The utility of this patent generates a receipt with barcode or manually entered code for manual entry by the consumer at the fueling dispenser at the time of fuel purchase. The price per unit adjustment occurs at the fueling dispenser prior to the consumer fueling process. This process relies fully upon the consumer and a fuel dispenser integrated barcode scanner or keypad for application of the reward.

U.S. Pat. No. 6,332,128 (Nicholson, Dec. 18, 2001) describes a fuel discounting process for cross-marketed products. Separate and unique discounts for each cross-marketed product may apply to the price per unit discounting of fuel. This process describes the similar printing of a receipt for which the consumer manually scans the barcodes on the receipt or manually enters a code into the fueling dispenser application for the adjustment of the price per unit of fuel. The price per unit adjustment occurs at the fueling dispenser prior to the consumer fueling process. This process relies fully upon the consumer and the referenced CAT for application of the reward.

U.S. Pat. No. 6,732,081 (Nicholson, May 4, 2004) describes a price per unit fuel discounting process through a similar process of validating the instance of an available price per unit discount through the consumer manual scanning of a barcode on a receipt to validate the price per unit discount then adjust said price per unit accordingly at the dispenser prior to the consumer fueling action. The price per unit adjustment occurs at the fueling dispenser prior to the consumer fueling process. This process relies fully upon the consumer and a fuel dispenser integrated barcode scanner for application of the reward.

U.S. Pat. No. 6,778,967 (Nicholson, Aug. 4, 2004) describes a process for cross-selling products and increasing fuel sales with the application of a discounted pre purchased voucher. The consumer may purchase a voucher for future redemption of fuel at the price today. This is a form of price hedging for the consumer. This process requires a manual scanning of a barcode or manual code entry by the consumer at the fueling dispenser.

U.S. Pat. No. 6,885,996 (Nicholson, Apr. 26, 2005) describes a process for the redemption of a discount across multiple vouchers each on the basis of individual cross-marketed products for the discount application on price per unit of fuel. This patent addresses the application of the rules for order of precedence of the redemption of the vouchers in full and partial redemption. This process relies fully upon the consumer and a fuel dispenser integrated barcode scanner or keypad for application of the reward.

U.S. Pat. No. 7,383,204 (Nicholson, Jun. 3, 2008) describes a process of price per unit discounts applied at the fuel dispenser with rewards awarded through cross-product sales. This patent applies to the accumulation of multiple awards functionally redeemable through stacking or the summation of all awards. This process relies fully upon the consumer and a fuel dispenser integrated barcode scanner or keypad for application of the reward.

U.S. Pat. No. 7,653,571 (Jacoves et al., Jan. 26, 2010) describes a process of a price per unit discount triggered by an initial purchase. The redemption of the reward occurs through consumer manual scanning of a barcode on a receipt issued at the initial purchase. This process requires consumer manual action to redeem and an integrated barcode scanner at the fuel dispenser.

U.S. Pat. No. 7,742,942 (Nicholson, Jan. 22, 2010) describes a process whereby credit card issuing bank in a business relationship with a vendor obtains price per unit rewards to the cardholder (consumer). The credit card loyalty points may convert to price per unit discounts as determined by the relationship agreement. This is an exchange rate process of converting points to price per unit discounts by select issuer to vendor affinity program relationship.

Earlier disclosures fail to disclose the innovative transaction flow disclosed in this present invention.

### SUMMARY OF THE INVENTION

The present innovation discloses a system of electronic transactions: Portable Pay At The Pump. The present system utilizes a number of various and distinct point-of-sale devices; fueling and charging stations, consumer mobile devices, and at least one mobile host platform, at least one transaction gateway, at least one incentives platform, at least one transaction rules engine, and several and various payment acquiring payment platforms. The system functions as platform-as-a-service (PaaS) and software-as-a-service (SaaS) solutions for electronic transactions, including but not limited to: secure payments (credit card, stored value/prepaid, vouchers), incentives (coupons, promotions, and loyalty), and other secure transactions. The gateway innovation is a critical component of the architecture having the capability of translating protocols and data format, as appropriate, for the intercommunications of disparate data information systems. A rules engine integrates tightly with the gateway to provide rules validation at the field or column level individually or as a grouping of compound rules. The Portable Pay At The Pump functionality is a unique and innovative approach platform leveraging the capabilities of the gateway, rules engine, and master host platform provisioning the portable application consumer payment identification, consumer loyalty identification, fueling/charging station identification, payment pre-authorization, fueling/charging station activation, and payment capture without any direct interaction between the consumer and the physical fueling/charging station infrastructure. This invention describes a fully and separate independent act by a consumer to notify a portable network of the select store, pump, and fuel grade through several optional means of notification via an fully independent device. The result is a more secure payment environment with significantly lower capital investment for the merchant and payment networks.

### BRIEF DESCRIPTION OF THE DRAWINGS

FIG. 1: PRE-AUTHORIZATION REQUEST/RESPONSE provides a visual process of use of Portable Pay At The Pump for the pre-authorization of the payment and pump activation in advance of the consumer fueling event.

FIG. 2: SALE CAPTURE REQUEST/RESPONSE provides a visual process of use of Portable Pay At The Pump for the capture of the fueling parameters relevant to the payment and pertinent data capture at conclusion of the consumer fueling event.

### DETAILED DESCRIPTION OF EXEMPLARY EMBODIMENTS

Throughout this discussion references to “payment” mean any form of application of reimbursement of services rendered. As such, a “payment” may mean submission of cash, credit card, debit card, stored value/prepaid card, gift card, gift certificate, incentive, discount, coupon, voucher, et cetera.

With respect to reference identification, the 3-digit identifiers so designate the following:

1. Series 100 denotes the Store Merchant infrastructure

2. Series 200 denotes the Service Agent [gateway/master host platform] infrastructure

3. Series 300 denotes the third-party independent payment processor

4. Series 800 denotes the process steps or pre-authorization and pump activation

5. Series 900 denotes the process steps for payment capture

As a point of reference to each of the FIGs, Pump [101] contains three (3) small graphics as reference to each of a FUEL GRADES [102] with display similar to 2D barcodes. This reference to a 2D barcode is illustrative only and not intended to be restrictive in nature. As stated previously the specific mechanisms for identifying a fuel PUMP [101] and FUEL GRADES [102] vary and independent of the claims of this innovation.

Throughout this detailed description references to pump mean petroleum dispenser, compressed natural gas dispenser, electronic (eV) charging station, or any other such device that provides a means of provisioning energy content to a device.

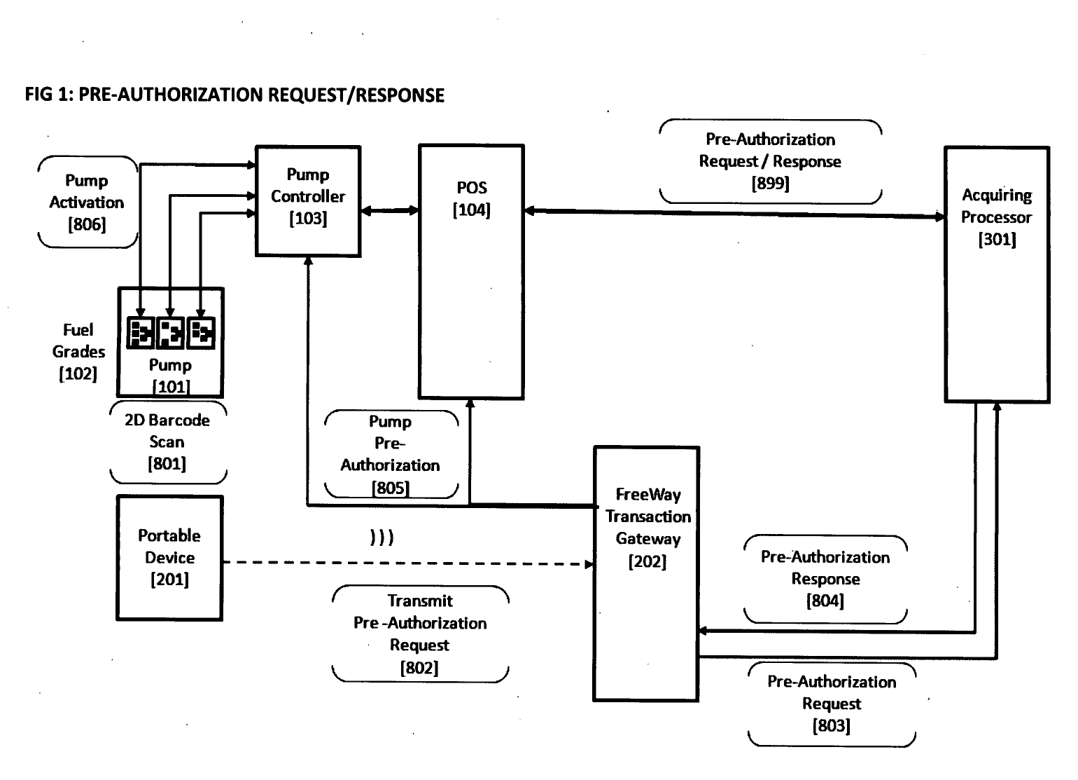

Discussions throughout this section reference the designations in FIG. 1: PRE-AUTHORIZATION REQUEST/RESPONSE.

Starting in the lower-left of FIG. 1, the consumer through the functionality of the PORTABLE DEVICE [201] initiates the pre-authorization and pump activation action through the physical process of identifying the specific fuel dispensing pump and grade of fuel. In this example, the using PORTABLE DEVICE [201], the consumer performs 2D BARCODE SCAN [801] of the desired FUEL GRADES [102] on the select PUMP [101].

The PORTABLE DEVICE [201] performs the program actions upon the contents of FUEL GRADES [102] in combination with other forms of validation and consumer identification prior to TRANSMIT PRE-AUTHORIZATION REQUEST [802].

TRANSMIT AUTHORIZATION REQUEST [802] delivers the authorization request to FREEWAY TRANSACTION GATEWAY [202] performing basic validation of the content of the request, validates the purchase and retrieves any discounted pricing, converts the consumer MOBILE DEVICE [201] to the appropriate payment mechanism, converts the FUEL GRADES [102] identification to the appropriate PUMP [101] and subsequently the appropriate merchant ID (MID) on the basis of the payment type and ACQUIRING PROCESSOR [301]. FREEWAY TRANSACTION GATEWAY [202] converts the pre-authorization request to the format and communications protocol as required by the specific ACQUIRING PROCESSOR [301].

FREEWAY TRANSACTION GATEWAY [202] routes the PRE-AUTHORIZATION REQUEST [803] in the certified format and network connection.

ACQUIRING PROCESSOR [301] performs the payment authorization as appropriate to the payment network in validation of the sufficient funds availability (ACH, credit, debit, stored value, et cetera).

ACQUIRING PROCESSOR [301] generates the standard format response for authorization or decline typically for an amount in excessive the typical fueling transaction. This pre-authorized amount is generally reserved against the balance available until a void, return, timeout, or transaction capture posted pursuant to the fueling activity and for the amount of the sale. The “amount of the sale” may be the full amount of the purchase transaction or a fraction thereof in the case of a split tender where a single or multiple forms of payment precede the final capture value.

PRE-AUTHORIZATION RESPONSE [804] is the process of the ACQUIRING PROCESSOR [301] response to the FREEWAY TRANSACTION GATEWAY [202] request. This occurs in predefined format and connectivity to which FREEWAY TRANSACTION GATEWAY [202] certifies to each select ACQUIRING PROCESSOR [301].

While the specifics of PUMP PRE-AUTHORIZATION [805] are beyond the scope of this innovation, this description provides what should be considered a typical pre-authorization for the purposes of example. FREEWAY TRANSACTION GATEWAY [202] initiates PUMP PRE-AUTHORIZATION [805] with minimum content being merchant ID (MID), pump identification, fuel grade, and pre-authorization amount. The format and content of PUMP PRE-AUTHORIZATION [805] may vary by merchant location due to variations in PUMP [101], PUMP CONTROLLER [103], and POS [104] and permutations thereof. Depending upon the specifics of these permutations, PUMP PRE-AUTHORIZATION [805] may interface directly either of POS [104] or PUMP CONTROLLER [103]. In every instance the transaction processes through PUMP CONTROLLER [103] either directly or indirectly after passing through the POS [104].

The details of the communications interface between the PUMP CONTROLLER [103] and PUMP [101] are beyond the scope of this innovation. However, it is suffice to state the transaction proceeds as typically performed today with pre-authorization content inclusive of PUMP [101], FUEL GRADES [102], and maximum monetary limit of the purchase. By example, as of this writing, for automotive the average fueling transaction may be $65.00. The balancing of consumer convenience and satisfaction against fraudulent transactions establishes a pre-authorization value of $75.00. Therefore, the pre-authorization amount is generally slightly greater than the typical payment capture value.

This completes the Portable Pay At The Pump innovation for pre-authorization. At this point in the transaction PUMP [101] is ACTIVATED for the select FUEL GRADES [102]. The consumer proceeds with the typical fueling process until reaching either a full fuel tank or desired spend limit.

### Portable Pay At The Pump Capture

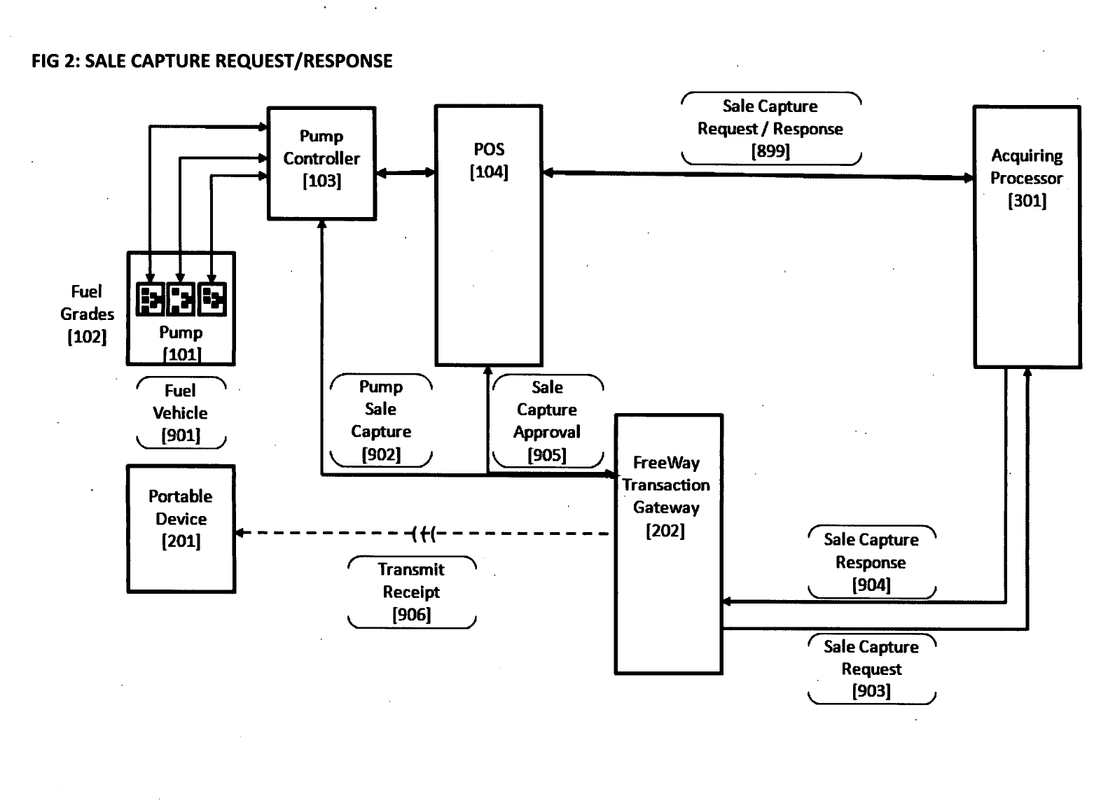

Discussions throughout this section reference the designations in FIG. 2: SALE CAPTURE REQUEST/RESPONSE.

Upon completion of the consumer activity, FUEL VEHICLE [901], the payment capture process proceeds as typical with little innovative change with the minor exception of consumer receipt presentation via email or the PORTABLE DEVICE [201].

PUMP [101] communicates fueling action complete with the monetary value of the sale and FUEL GRADES [102] to PUMP CONTROLLER [103] in the designed format and protocol.

PUMP CONTROLLER [103] communicates the total sale to POS [104] for sales reporting and management at a minimum. In some implementations, PUMP CONTROLLER [103] communicates directly to FREEWAY TRANSACTION GATEWAY [202] via PUMP SALE CAPTURE [902] as a design methodology to restrict payment security scope (e.g. PCI DSS) requirements from POS [104]. In other implementations, PUMP CONTROLLER [103] communicates all sales and payment activities through POS [104] to FREEWAY TRANSACTION GATEWAY [202].

FREEWAY TRANSACTION GATEWAY [202] performs the payment transaction capture for the amount of sale against the transaction ID identifying the pre-authorization request via a standard process dependent upon ACQUIRING PROCESSOR [301].

ACQUIRING PROCESSOR [301] cross-references the pre-authorization transaction to the actual value of the sale in this capture and releases the financial hold on the balance of the pre-authorization request.

ACQUIRING PROCESSOR [301] responds with SALE CAPTURE RESPONSE [904].

FREEWAY TRANSACTION GATEWAY [202] completes all logging and transaction detail capture and provides SALE CAPTURE APPROVAL [905] to the appropriate device: PUMP CONTROLLER [103] or POS [104]. In either instance the sale approval terminates in POS [104] in support of financial reconciliation at end-of-shift, end-of-day, and end-of-period.

What is claimed is:

1. A method using a portable device (non-fixed-to-the-dispenser device, such as, consumer of third party issued mobile phone, tablet computer, or other such device) of electronic transactions at a fueling dispenser (petroleum dispenser, compressed natural gas dispenser, electronic (eV) charging station, et al.) provisioning:
identification of the consumer;
abstract reference to and selection of a payment method (credit, debit, stored value, electronic check, et al.);
identification of the fueling point-of-sale through any individual or combination of technologies available via the portable device (scanning 1D barcode, scanning 2D barcode, manual selection via a listing, manual selection via a graphical representation, manual key entry of a dispenser identifier, photo recognition, optical character recognition (OCR), geographical positioning system (GPS), radio frequency identification (RFID), Bluetooth®, audio signaling, et al.);
for the purposes of initiating a fueling transaction, including but not limited to, payment, marketing awards, marketing rewards, and dispenser activation.

2. A method using a portable device for transaction interface with a dispenser without any physically integrated electronic reading or receiving device with said dispenser;

3. A method using a portable device to capture and pass a dispenser identifier through the mobile device and mobile network, private network, or Internet to initiate, process, and complete the transaction (the transaction does not transmit consumer identification or consumer payment identification through the pump dispenser or retail merchant networking infrastructure);

4. A method using a portable device for transmitting the consumer identification and consumer payment identification for the purpose of electronic payment of the fueling process without passing said information through the merchant fueling dispenser and local network infrastructure;

5. A method using a portable device for transmitting the consumer identification for the purpose of receiving and redeeming loyalty incentives in the form of discounts for immediate or future purchases without passing said information through the merchant fueling dispenser and local network infrastructure;

6. A method using a portable device to collect line item specific purchase data in real-time and as part of the purchase transaction detail improving the capture of detailed sales line item data.

7. A method using a portable device to collect other transaction data from other devices and databases in real-time for the purpose of capturing additional consumer, vehicle, and other data supporting improved consumer purchase metrics, consumer characteristics, time of purchase conditions, fraud protection, marketing metrics, et al.
